(19) United States
(12) Patent Application Publication
(10) Pub. No.: US 2025/0207751 A1
(43) Pub. Date: Jun. 26, 2025

(54) LIGHTING DEVICE FOR VEHICLES, AND CONTROL METHOD

(71) Applicant: Hella GmbH & Co. KGaA, Lippstadt (DE)

(72) Inventors: Hamza Akin, Lippstadt (DE); Andreas Lintz, Lippstadt (DE); Maximilian Mevenkamp, Hamm (DE)

(21) Appl. No.: 19/079,091

(22) Filed: Mar. 13, 2025

Related U.S. Application Data
(63) Continuation of application No. PCT/EP2023/074865, filed on Sep. 11, 2023.

(30) Foreign Application Priority Data
Sep. 19, 2022 (DE) 10 2022 123 952.7

(51) Int. Cl. F21S 41/663; F21S 41/25; F21S 45/60

(52) U.S. Cl. CPC F21S 41/663; F21S 41/25; F21S 45/60

(57) ABSTRACT

A lighting device for vehicles is provided with a housing with a lens that covers an opening in the housing. A light source unit is positioned inside the housing, and contains a plurality of light sources for generating a predefined light distribution. A control unit of the light source unit generates a control signal with which the light source unit can be controlled. The control signal switches off the light source unit with a switch-off protocol. Sections of the light sources in the light source unit are successively switched off and/or dimmed within an anti-condensation period (t_{A}), such that no condensation accumulates on the inner surface of the lens.

### CROSS REFERENCE

This application claims priority to PCT Application No. PCT/EP2023/074865, filed Sep. 11, 2023, which itself claims priority to German Application No. 10 2022 123952.7, filed Sep. 19, 2022, the entireties of both of which are hereby incorporated by reference.

### FIELD OF THE INVENTION

The invention relates to a lighting device for vehicles that has a housing with a lens that covers an opening in the housing, a light source unit that contains numerous light sources inside the housing for generating a predefined light distribution, and a control unit for generating a control signal with which the light source unit can be controlled.

The invention also relates to a control method for a light source unit in the lighting device.

### BACKGROUND OF THE INVENTION

EP 2 014 972 B1 discloses a Peltier device for preventing undesired condensation on optical components in a lighting device for vehicles. This keeps the temperature inside the housing above the dew point for the optical component.

An infrared lamp is integrated in the housing for a lighting device for vehicles in EP 3 822 536 A1, which keeps the temperature inside the housing at a level that prevents condensation.

DE 10 2019 108 312 A1 discloses a lighting device for vehicles in which the light sources are switched on and off sequentially to generate a wiping lighting effect. This lighting effect generates a signal light function.

### BRIEF SUMMARY OF THE INVENTION

The object of the present invention is to therefore create a lighting device and a method for controlling a light source unit with which undesired condensation on the inner surface of an optical component in the lighting device can be prevented in a simple manner.

To solve this problem, in an example embodiment, the control signal is designed to switch off the light source unit with a switch-off protocol, according to which at least some of the light sources in the light source unit are switched off and/or dimmed successively during an anti-condensation period, such that no condensation accumulates on the inner surface of a lens.

According to the invention, light sources in the light source unit are switched off gradually, according to a switch-off protocol, such that no condensation accumulates on the inner surface of a lens. This advantageously does not require any additional components. Undesired condensation is simply prevented by gradually switching off the light source unit. The fundamental concept of the invention is to intelligently reduce the brightness of the light source unit, or light sources therein, during an anti-condensation period (switch-off period) smoothly or in increments, such that condensation does not accumulate on the inner surface of the lens.

According to a preferred embodiment of the invention, the anti-condensation period and/or decrease in the brightness of the light source unit is such that the air temperature inside the housing remains higher than the condensation temperature during the anti-condensation period.

According to another aspect of the invention, the brightness of the light source unit decreases gradually, such that the temperature on the inner surface of the lens is at least 2 K, preferably 5 K, higher than the dew point temperature for the air therein. This results in a safety buffer, such that in the event of an abrupt change in the environmental conditions, condensation accumulation on the lens is reliably prevented.

According to another aspect of the invention, the light source unit contains numerous light sources arranged in a matrix, such that sequential deactivation of the individual light sources results in a basically linear reduction in the brightness of the light source unit. If this linear reduction takes place over at least two hours (minimum switch-off period), condensation accumulation on the lens is reliably prevented.

In an alternative design, a decrease in the brightness of the light source unit can also be obtained by dimming at least some of the light sources. This advantageously results in a simple means of obtaining a desired switch-off curve for the brightness of the light source unit.

According to another aspect of the invention, the decrease in brightness can follow a parabolic curve instead of a linear course, thus shortening the necessary anti-condensation period. Because the brightness of the light source unit does not decrease as radically at the start of the switch-off process, the temperature inside the housing can be kept relatively high initially. This prevents a decrease in the interior temperature to below a specific temperature after completion of the switch-off process.

The method obtained with the invention is characterized in that at least some of the light sources in the light source unit are switched off and/or dimmed successively, such that the brightness of the light source unit decreases continuously during the switch-off process, until reaching a total blackout at the end of the process.

The particular advantage of the invention is that the temperature inside the housing can be kept high enough to prevent condensation on the lens by switching off the light source unit gradually. This advantageously requires a switch-off process for the light source unit that is based only on empirical data. Additional components are not needed.

In a preferred embodiment of the invention, the brightness of the light source unit is decreased linearly during a minimal anti-condensation period. This minimal anti-condensation period is preferably 2 hours, in order to prevent a radical temperature decrease that would result in falling below the dew point temperature. Undesired condensation can be advantageously prevented during a linear reduction in brightness.

In an alternative design, the decrease in the brightness of the light source unit follows a parabolic curve. Compared with a linear reduction of the brightness, the decrease in the temperature on the inside is not as great initially, thus shortening the necessary anti-condensation period.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a block diagram of the lighting device obtained with the invention.

FIG. 2 shows a light source unit that contains numerous light sources that can be switched off successively, and the associated decrease in the brightness of the light source unit.

FIG. 3 shows the light source unit with numerous light sources dimmed simultaneously, and an associated decrease in the brightness of the light source unit.

FIG. 4 shows the light source unit with numerous light sources dimmed simultaneously, and a decrease in the brightness following a parabolic curve shown in the graph.

FIG. 5 shows the temperature curve inside the housing for a linear decrease in the brightness shown in FIGS. 2 and 3, with different switch-off periods (anti-condensation periods).

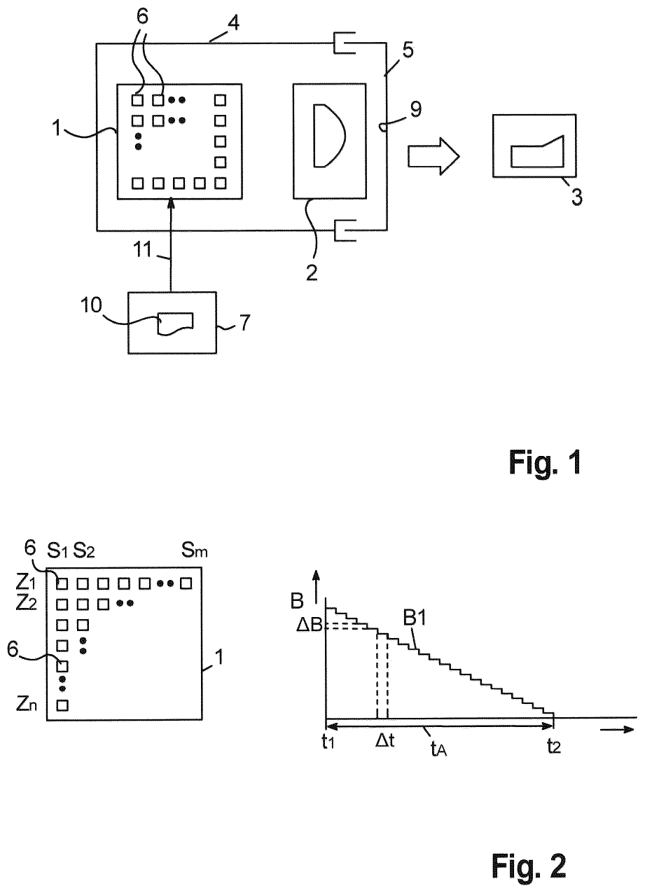

### DETAILED DESCRIPTION OF THE DRAWINGS

A lighting device for vehicles contains a light source unit 1 with a dedicated optical unit 2 that contains a lens for generating a predefined light distribution, e.g. a low beam light distribution 3. The light source unit 1 and optical unit 2 are in a housing 4 for the lighting device. An opening in the housing 4 is covered by a transparent lens 5.

The light source unit 1 contains numerous light sources arranged in a matrix, preferably LEDs 6.

The light source unit 1 has a dedicated control unit 7 with which the individual light sources 6 can be switched on and off, or dimmed.

The lighting device is a high-resolution headlamp containing numerous light sources 6 in an n x m matrix. A first part of the light sources 6 has a first primary lens (not shown). A second part of the light sources 6 has a second primary lens (not shown). When the first part of the light sources 6 is switched on, the lenses in the optical unit 2 generate the low beam light distribution 3, and when the second part of the light sources 6 are also switched on, a high beam light distribution is generated (not shown).

To prevent undesired condensation on the inner surface 9 of the lens 5, the control unit 7 has a program 10 with which a control signal 11 is generated that switches off the light sources 6 in a controlled manner, e.g. from an “on” state that generates the low beam light distribution 3. The control unit 7 can contain a microprocessor, for example, which has a memory in which the program 10 is stored. The program 10 could also be a hard-wired program in a microcontroller.

According to a first embodiment of the invention shown in FIG. 2, the light sources 6 that are switched on for the low beam light distribution 3, which are arranged in n rows Z₁, Z₂, . . . . Zₙ and m columns S₁, S₂, . . . . Sₘ, are switched off sequentially, either in rows or columns, such that the brightness B of the light source unit 1 decreases in increments, starting at an initial time t₁ for a switch-off period t_{A} and ending at a final time t₂ of this switch-off period t_{A}. At every interval Δt, the brightness decreases by the difference ΔB of the brightness of a single light source 6. This results in an incremental decrease in brightness B1, which is nearly linear. The switch-off period t_{A} forms an anti-condensation period that ensures that no condensation is formed on the inner surface 9 of the lens 5.

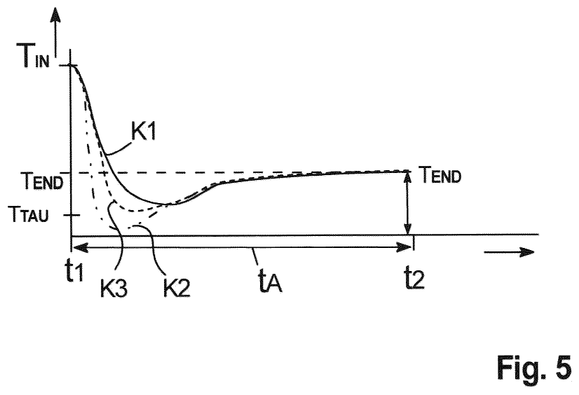

The curve of an internal housing temperature T_{IN} is shown in FIG. 5 as a function of the duration of the switch-off process during the switch-off period t_{A}. In this exemplary embodiment, the switch-off period ta lasts for three hours, such that the temperature curve K1 shown in FIG. 5 is obtained. The temperature T_{IN} drops abruptly after starting the switch-off process at the time t₁. It never reaches the temperature T_{TAU} at which condensation would occur. Instead, the curve K1 flattens out at a temperature difference At which is 5 K above the condensation temperature T_{TAU}, where it then levels off. If the light source unit 1 were to be switched off abruptly by switching off all of the light sources 6 simultaneously, the curve K2 would be obtained, which levels off at the same end value T_{END}, but it would first fall below the condensation temperature T_{TAU}, resulting in condensation on the lens 5.

A shorter switch-off period t_{A} results in a higher condensation temperature T_{TAU}, or a lower end temperature T_{END}. With a switch-off period ta of two hours, the curve K3 is obtained, which also does not result in a temperature falling below the condensation temperature T_{TAU}.

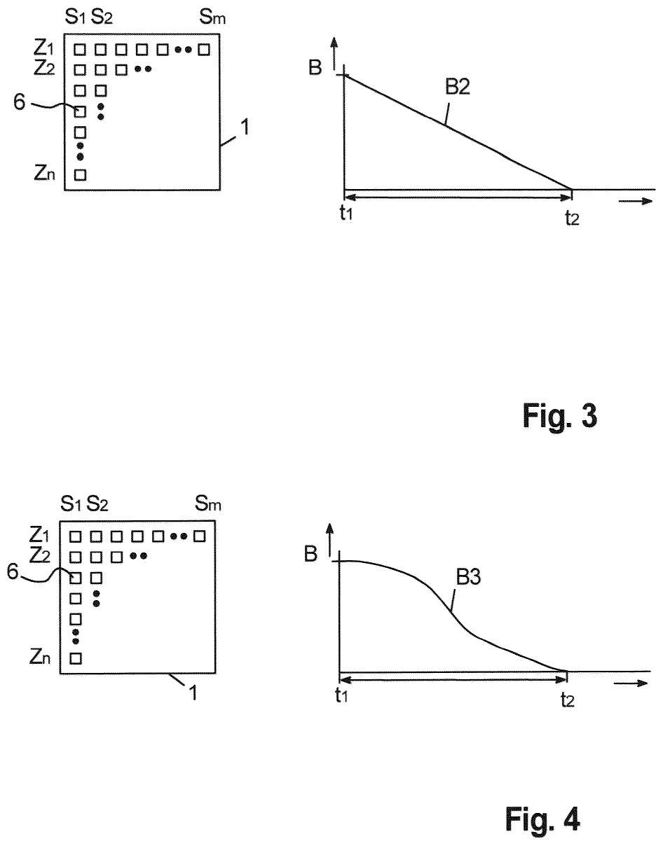

In an alternative embodiment, shown in FIG. 3, at least some of the light sources 6 in the light source unit 1 are also dimmed to a lower brightness B, such that brightness B of the light source unit 1 decreases or diminishes linearly. Instead of an incremental curve, a linear decrease B2 in the brightness B is obtained. If the switch-off period ta lasts at least 2 hours, it is ensured that the temperature difference curve K3 remains above the condensation temperature T_{TAU}.

In another embodiment of the invention, shown in FIG. 4, the light sources 6 in the light source unit 1 can also be switched off successively and/or simultaneously dimmed to a lower brightness B, such that the decrease in brightness B3 follows a parabolic curve between the starting time t₁ of the switch-off period t_{A} and the end time t₂. This prevents the temperature from dropping below that in FIG. 5, making it possible to shorten the overall switch-off period t_{A}.

### LIST OF REFERENCE SYMBOLS

1 light source unit
2 optical unit
3 low beam light distribution
4 housing
5 lens
6 light source
7 control unit
8 printed circuit board
9 inner surface
10 switch-off program/switch-off protocol
11 control signal
B brightness
B1 brightness decrease
B2 linear decrease
B3 brightness
K1, K2, K3 temperature curve
T_{A1} starting time
t_{A} switch-off period
T_{A2} end time
Δₜₘᵢₙ, Δt temperature difference
ΔB difference
T_{TAU} condensation temperature
T_{IN} internal housing temperature
T_{END}end value
T_{S} temperature
Z₁, Z₂, . . . . Zₙ n rows
S₁, S₂, . . . . Sₘ m columns

1. A lighting device for vehicles, the lighting device comprising:
a housing with an opening;
a lens that covers the opening in the housing;
a light source unit inside the housing, the light source containing:
a plurality of light sources for generating a predefined light distribution, and
a control unit for generating a control signal for controlling the light source;
wherein the control signal switches off the light source unit with a switch-off protocol, according to which sections of the light sources in the light source unit are successively switched off and/or dimmed within an anti-condensation period (t_{A}), such that no condensation accumulates on the inner surface of the lens.

2. The lighting device according to claim 1, wherein the switch-off protocol switches off and/or dims the light sources successively during the anti-condensation period, during which the temperature (T_{IN}) inside the housing remains higher than the condensation temperature (T_{TAU}).

3. The lighting device according to claim 1, wherein the switch-off protocol causes the temperature (T_{IN}) on the inner surface of the lens to be higher than the condensation temperature (T_{TAU}) by at least 2 Kelvin.

4. The lighting device according to claim 1, wherein the control protocol causes the light sources in the light source unit to be switched off successively.

5. The lighting device according to claim 1, wherein the control protocol causes at least some of the light sources to dim during the anti-condensation period (t_{A}) to obtain a predefined, lower brightness (B).

6. The lighting device according to claim 1, wherein the light sources are controlled such that the brightness (B) of the light source unit during the anti-condensation period (t_{A}) decreases linearly or in increments.

7. The lighting device according to claim 6, wherein the anti-condensation period (t_{A}) lasts at least two hours.

8. The lighting device according to claim 1, wherein the light sources are controlled such that the decrease in the brightness (B) follows a parabolic curve during the anti-condensation period (t_{A}).

9. The lighting device according to claim 1, the light sources are controlled at a start (t₁) of the switch-off process (t_{A}) to generate the low beam light distribution.

10. A method for controlling a light source unit that contains numerous light sources in a motor vehicle according to claim 1, the method comprising the step of:
successively switching off and/or dimming at least some of the light sources in the light source unit, such that the brightness (B) of the light source unit decreases continuously during the switch-off process (t_{A}), until the brightness (B) reaches a full blackout at an end (t₂) of the switch-off process (t_{A}).

11. The method according to claim 10, wherein when the brightness (B) of the light source unit during the switch-off period (t_{A}) is reduced, the decrease in temperature on the inner surface of the lens and/or inside the housing is small enough that the temperature on the inner surface of the lens and/or the temperature (T_{IN}) inside the housing remains higher than the dew point temperature (T_{TAU}).

12. The method according to claim 10, wherein the brightness (B) of the light source unit decreases linearly during a switch-off period (t_{A}) of at least two hours.

13. The method according to claim 11, wherein the decrease in the brightness (B) of the light source unit follows a parabolic curve during a switch-off period (t_{A}) of at least 1 hour.
